(19) United States
(12) Patent Application Publication
(10) Pub. No.: US 2025/0272477 A1
(43) Pub. Date: Aug. 28, 2025

(54) MACHINE LEARNING LARGE LANGUAGE MODEL ENSEMBLE DEPLOYMENT IN CONTENT SUMMARIZATION

(71) Applicant: Vaibhav BHAN, Toronto (CA)

(72) Inventor: Vaibhav BHAN, Toronto (CA)

(21) Appl. No.: 19/205,600

(22) Filed: May 12, 2025

Related U.S. Application Data
(63) Continuation-in-part of application No. 18/677,965, filed on May 30, 2024.
Application No. 18/677,965 is a continuation-in-part of application No. 18/618,194, filed on Mar. 27, 2024.
Application No. 18/618,194 is a continuation-in-part of application No. 18/107,714, filed on Feb. 9, 2023, now Pat. No. 12,236,451.
Application No. 18/107,714 is a continuation-in-part of application No. 17/204,324, filed on Mar. 17, 2021, now Pat. No. 11,605,004.
Application No. 17/204,324 is a continuation-in-part of application No. 16/216,038, filed on Dec. 11, 2018, now Pat. No. 11,030,533.

(51) Int. Cl. G06F 40/166; G06F 40/30; G06N 3/04

(52) U.S. Cl. CPC G06F 40/166; G06F 40/30; G06N 3/04

(57) ABSTRACT

System and method generating a summarization of text content, performed in a machine learning neural network large language model (LLM) ensemble. The method comprises inputting text content that includes an unstructured text dataset to a trained baseline LLM. The LLM ensemble includes the trained baseline LLM, a trained classification LLM, and multiple finetuned LLMs. Generating, based on performing natural language processing tasks, a baseline summary of the text content based on the trained baseline LLM, and a classification of topics of the text context via the trained classification LLM. Generating respective finetuned LLM summaries of the text based upon inputting the text content to the multiple finetuned LLMs. Determining, based on a semantic similarity analysis, respective text semantic similarity measures across the baseline summary compared to the finetuned LLM summaries. And generating a summarization of the text content for a topic based on the similarity measures.

### RELATED APPLICATIONS

This application is a continuation-in-part of, and claims benefit of priority to, U.S. patent application Ser. No. 18/677,965 filed: May 30, 2024, which in turn claims benefit of priority to U.S. patent application Ser. No. 18/618,194 filed Mar. 27, 2024 which in turn claims benefit of priority to U.S. patent application Ser. No. 18/107,714 filed Feb. 9, 2023 which in turn claims benefit of priority to U.S. patent application Ser. No. 17/204,324 filed Mar. 17, 2021 now issued as U.S. Pat. No. 11,605,004 which in turn claims benefit of priority to U.S. patent application Ser. No. 16/216,038 filed Dec. 11, 2018 now issued as U.S. Pat. No. 11,030,533. The aforementioned priority application Ser. Nos. 18/677,965, 18/618,194, 18/107,714, 17/204,324 and 16/216,038 are hereby incorporated in their entirety.

### TECHNICAL FIELD

Disclosures herein relate to artificial intelligence, or machine learning, large language models and deployment thereof.

### BACKGROUND

Machine learning is a subset of AI that focuses on algorithms enabling systems to learn from data without being explicitly programmed. Large language models (LLMs) are a specific type of machine learning model, particularly deep learning models, designed for natural language processing tasks. Machine learning can be used for text recognition, image recognition, video recognition, generating recommendations and predictions, data security, fraud detection, as well as, but not limited to, natural language processing. A machine learning model may be trained, for example, using one or more training dataset of labeled data samples. Machine learning models may be configured based on decision trees, support vector machines, k-nearest neighbors, k-means clustering, random forests, linear regression, logistic regression, and gradient boosting algorithms, among other schemes.

Machine learning LLMs may be trained on datasets of text and code, allowing them to recognize patterns and relationships between words and phrases LLMs may be a key component of generative AI, which refers to AI systems that can create new content, such as text, images, or code. LLMs may use machine learning neural networks to analyze unstructured data and, for example, make predictions about the next word or phrase in a sequence. Additional examples of LLM applications can include, without limitation, text generation, translation, question answering, and chatbot development.

### BRIEF DESCRIPTION OF THE DRAWINGS

Whereas novel aspects believed characteristic of the invention are set forth in the appended claims, embodiments described herein will be understood with reference to the following detailed description and accompanying drawing figures, in which like reference numerals indicate similar or identical features and components.

FIG. 1 illustrates, in an example embodiment, a machine learning neural network large language model (LLM) ensemble deployed in summarization of text content.

FIG. 2 illustrates, in an example embodiment, an architecture of a machine learning neural network LLM ensemble deployed in summarization of text content.

FIG. 3 illustrates, in an example embodiment, a method of operation of a machine learning neural network LLM ensemble in performing summarization of text content.

FIG. 4 illustrates, in an example embodiment, a method of training a machine learning neural network LLM ensemble deployed in summarization of text content.

FIG. 5 illustrates, in an example embodiment, a method of further deploying a machine learning neural network LLM ensemble in summarization of text content.

FIG. 6 illustrates, in an example embodiment, a method of deploying a machine learning neural network LLM ensemble in summarization of text content based on sentiment expressions contained therein.

### DETAILED DESCRIPTION

Embodiments herein, among other aspects, provide systems and methods of training and deploying an artificial intelligence (AI) machine learning (ML) large language (LLM) ensemble. The machine learning ensemble includes a collection of multiple specialized machine learning models in conjunction with context-engineered, or context-optimized, prompts. Systems and methods herein provide a machine learning LLM ensemble that can be leveraged to provide a summarization of content that is most accurate and relevant, including in conjunction with engineered prompts.

Embodiments herein enable generation of relevant and accurate summaries of complex text content. With vast quantities of data being produced daily across various domains-ranging from scientific research to financial reports, and even encompassing technological products and product or manufacturer reviews-individuals and organizations face the challenge of distilling essential information swiftly and effectively. Accurate summaries serve as vital tools for decision-making, enabling professionals to comprehend and discover key insights, preferably without wading through vast amounts of text content. Moreover, succinct summaries enhance accessibility, making detailed content manageable for broader audiences, including those with time constraints or limited subject expertise. Embodiments provided herein facilitate sophisticated, automated summarization techniques and solutions that can support informed decision-making and efficient communication, whilst also empowering users to navigate an ever-expanding landscape of digital information and content with confidence.

Embodiments herein provide a LLM ensemble approach that recognize, and leverage, a combination of LLM model diversity, complementary strengths, and comprehensive output synthesis. The ensemble methods leverage multiple models, each with its distinct architecture and learning biases. This diversity ensures that weaknesses in one model are offset by strengths in others. For instance, while one LLM might excel in fluency, another might be better at precision and recall, providing a comprehensive output that balances these qualities. The ensemble methods herein provide advantages and benefit versus individual models that introduce and are subject to idiosyncratic errors, whether due to omissions of critical information or inclusion of irrelevant details. By aggregating outputs, the ensemble approach eliminates or minimizes such errors, generating a cleaner, more accurate summary. The ensemble approach disclosed herein also provides enhanced contextual understanding, since different LLM models often “see” and interpret aspects of text differently. An ensemble can synthesize these varying interpretations to build a more holistic understanding of the input text, translating into summaries that better capture nuances and complexities. The ensemble approach additionally increases the confidence level of predictions by considering multiple outputs. Predictions that are supported by multiple models are typically more reliable, as they stem from a consensus of interpretations rather than relying on a single standpoint. Each LLM in the ensemble might leverage distinct mechanisms for contextualizing and semantic representation of the input text. By combining these, the ensemble better captures semantic richness and subtlety, leading to enriched, accurate summaries and topic identifications.

Provided is a method of generating a summarization of text content, the method performed in a machine learning neural network large language model (LLM) ensemble. The method, in some embodiments, includes inputting, into a trained baseline LLM, the text content that includes at least an unstructured text dataset, the LLM ensemble including at least the trained baseline LLM, a trained classification LLM, and multiple finetuned LLMs, the LLM ensemble being instantiated in one or more processor devices of a computing system. The method also includes generating, based on performing respective natural language processing tasks in the one or more processor devices, (i) a baseline summary of the text content in accordance with the trained baseline LLM, and (ii) a classification of topics of the text context in accordance with the trained classification LLM. The method includes generating respective finetuned LLM summaries of the text based at least in part upon inputting the text content to respective ones of the multiple finetuned LLMs, the multiple finetuned LLMs being selected in accordance with respective ones of the classification of topics; determining, based on a semantic similarity analysis performed in the one or more processors, respective text semantic similarity measures (also referred to herein as “similarity measures”) across the baseline summary compared to each of the respective finetuned LLM summaries. And further, generating, as an output result of the LLM ensemble, a summarization of the text content for at least one topic of the classification of topics based at least in part on the respective similarity measures.

In other embodiments, the method further includes deploying the LLM ensemble in summarization of text content that relates to products and services, including named product brands and service brands. The text content of interest may be selected for summarization based on one, or both, of a high sentiment intensity rating and a net sentiment score that is associated with the text content.

Also provided is a server computing system implementing summarization of text content. The server computing system, in embodiments comprise one or more processor devices and a memory storing instructions executable in the one or more processor devices. The instructions, when executed, cause the one or more processor devices to execute operations comprising inputting the text content to a trained baseline LLM of a LLM ensemble that includes at least the trained baseline LLM, a trained classification LLM, and multiple finetuned LLMs, the text content including at least an unstructured text dataset, the LLM ensemble being instantiated in one or more processor devices of a computing system; generating, based on performing respective natural language processing tasks in the one or more processor devices, (i) a baseline summary of the text content in accordance with the trained baseline LLM, and (ii) a classification of topics of the text context in accordance with the trained classification LLM; generating respective finetuned LLM summaries of the text based at least in part upon inputting the text content to respective ones of the multiple finetuned LLMs, the multiple finetuned LLMs being selected in accordance with respective ones of the classification of topics; determining, based on a semantic similarity analysis performed in the one or more processors, respective text semantic similarity measures across the baseline summary compared to each of the respective finetuned LLM summaries; and generating, as an output result of the LLM ensemble, a summarization of the text content for at least one topic of the classification of topics based at least in part on the respective similarity measures.

Further provided is a non-transitory computer readable medium storing instructions executable in one or more processor devices. The instructions, when executed in the one or more processors, cause the one or more processor to implement operations comprising inputting the text content to a trained baseline LLM of a LLM ensemble that includes at least the trained baseline LLM, a trained classification LLM, and multiple finetuned LLMs, the text content including at least an unstructured text dataset, the LLM ensemble being instantiated in one or more processor devices of a computing system; generating, based on performing respective natural language processing tasks in the one or more processor devices, (i) a baseline summary of the text content in accordance with the trained baseline LLM, and (ii) a classification of topics of the text context in accordance with the trained classification LLM; generating respective finetuned LLM summaries of the text based at least in part upon inputting the text content to respective ones of the multiple finetuned LLMs, the multiple finetuned LLMs being selected in accordance with respective ones of the classification of topics; determining, based on a semantic similarity analysis performed in the one or more processors, respective text semantic similarity measures across the baseline summary compared to each of the respective finetuned LLM summaries; and generating, as an output result of the LLM ensemble, a summarization of the text content for at least one topic of the classification of topics based at least in part on the respective similarity measures.

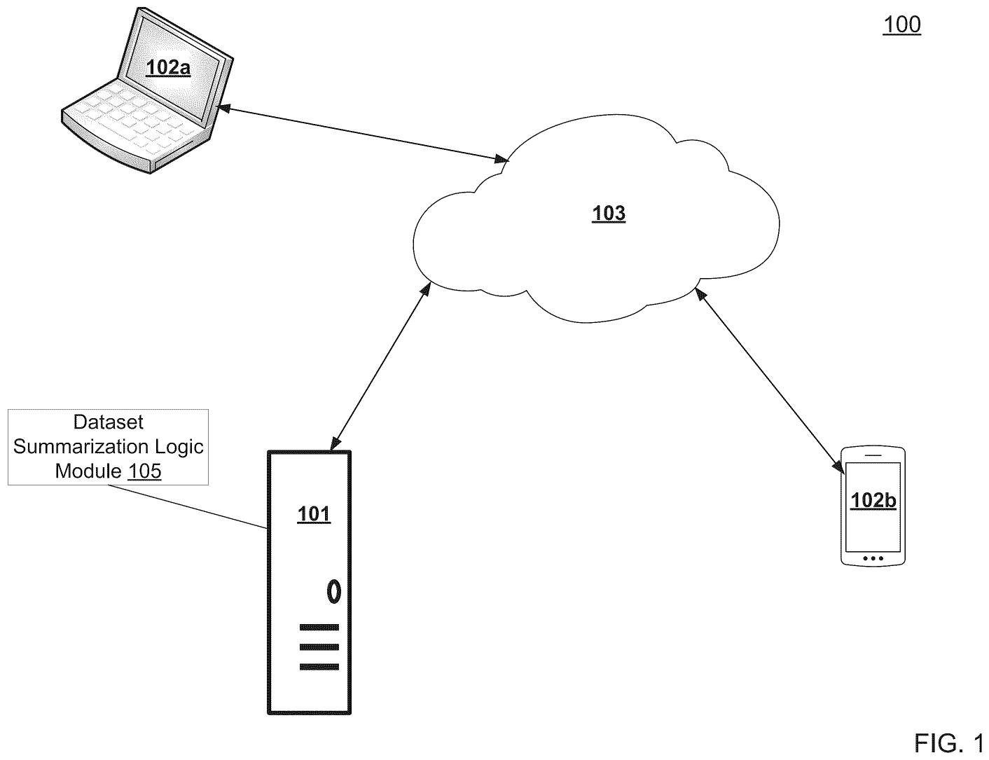

FIG. 1 illustrates, in an example embodiment, a machine learning neural network large language model (LLM) ensemble system 100 deployed in summarization of text content. In embodiments, machine learning neural network LLM ensemble system 100 includes computing and communication desktop or laptop device 102a and handheld, or mobile, computing and communication device 102b (variously and collectively referred to herein as computing and communication device 102) communicatively coupled to server computing system 101 via wide area network, or internet, 103. Server computing system 101, which may be manifested across multiple server computing devices in some embodiments, includes dataset summarization logic module 105. Dataset summarization logic module 105 provides executable logic instructions that may be instantiated in one or more processor devices to manifest, or provide, a machine learning neural network large language model (LLM) ensemble deployed in summarization of text content. In some embodiments, server computing system 101 may be positioned in a mobile platform, rather than in a fixed platform or location. In related embodiments, it is contemplated that the logic instructions constituting dataset summarization logic module 105 may be hosted, partially or otherwise, in other computing or server systems communicatively coupled to, or communicatively accessible within, machine learning neural network LLM ensemble system 100, as will be apparent to those of skill in the art of computing and communication networks.

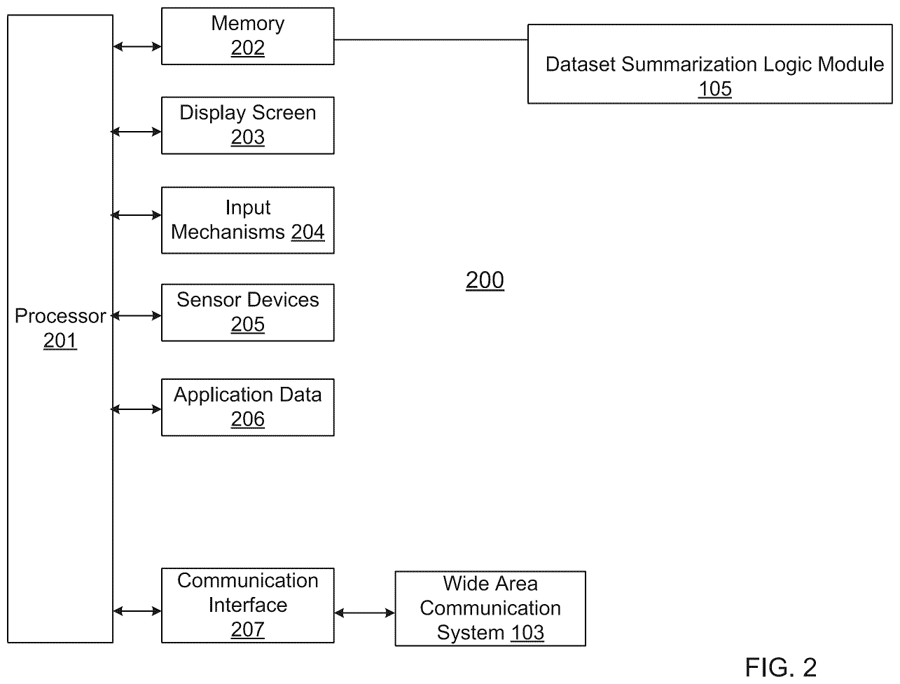

FIG. 2 illustrates, in an example embodiment, architecture 200 of machine learning neural network LLM ensemble system 100 deployed in summarization of text content. Architecture 200, in embodiments, may be implemented on, for example, a server or combination of servers communicatively interconnected. In one implementation, architecture 200 includes processor 201, memory resources 202 (e.g., read-only memory (ROM) or random-access memory (RAM)), and communication interface 207 communicatively coupled within machine learning neural network LLM ensemble system 100. Memory resources 202 may include instructions, constituting dataset summarization logic module 105, that are executable in processor 201. Memory resources 202 may also be used to store temporary variables or other intermediate information during execution of program instructions by processor 201.

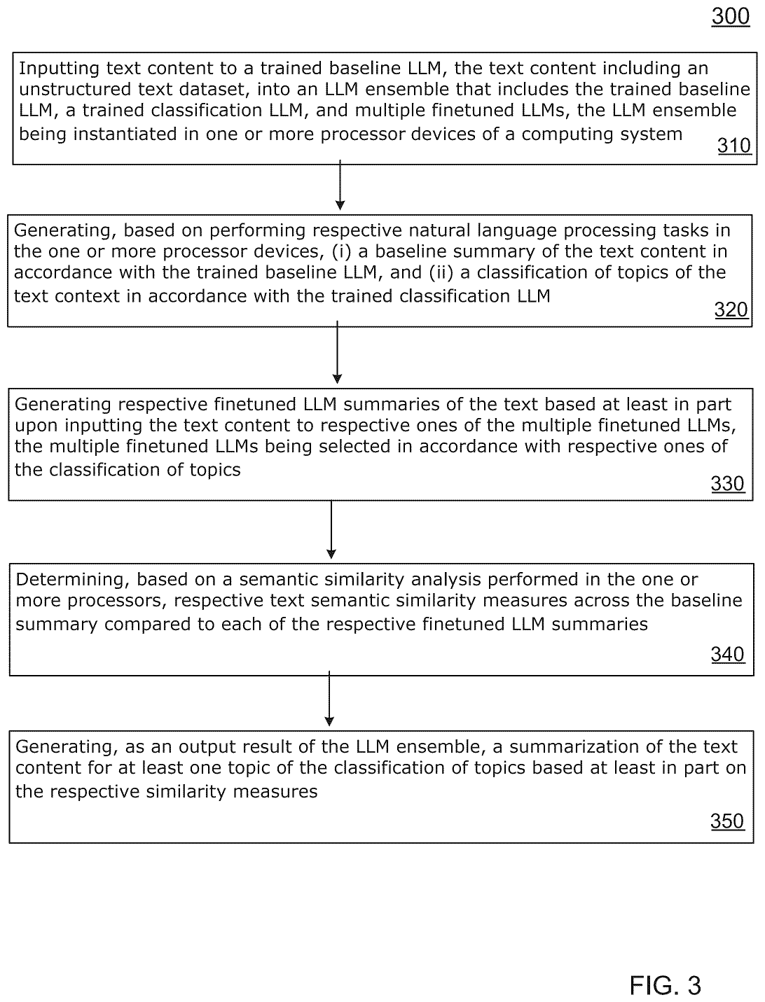

Architecture 200 may include display screen 203 and input mechanisms 204. As described by various examples, processor 201 can detect and process any number of sensor inputs from input sensor devices 205. As such, examples described herein are related to the use of the server computer system 200 for implementing the techniques described herein. According to an aspect, techniques are performed by way of architecture 200 in response to the processor 201 executing one or more sequences of one or more instructions contained in memory 202. Such instructions may be read into memory 202 from another machine-readable medium. Execution of the sequences of instructions contained in memory 202 causes the processor 201 to perform the process steps described herein, including process steps of the embodiments described herein in conjunction with, for example, the embodiments as described in FIGS. 3-6 herein. In alternative implementations, hard-wired circuitry may be used in place of or in combination with software instructions to implement examples described herein. Thus, the examples described are not limited to any specific combination of hardware circuitry and software. In some embodiments, communication interface 207 provides bi-directional communication and computing accessibility between communication server computing system 101, including dataset summarization logic module 105 constituted therein, and other devices and systems of machine learning neural network LLM ensemble system 100 as described herein.

Dataset summarization logic module 105, in embodiments, includes instructions for inputting text content to a trained baseline LLM. The text content can include at least an unstructured text dataset. The LLM ensemble, in embodiments, is instantiated in one or more processor devices of server computing system 101, and includes at least a trained baseline LLM, a trained classification LLM, and multiple finetuned LLMs. The trained classification LLM may be deployed to provide a classification of topics based on, and inherent to, the given text content. In some aspects, the text content may be embodied in the text content of the unstructured text dataset further comprises in one, or both, of image content and audio content.

In some embodiments, a performance baseline may be established using a Large Language Model (LLM) that provides language generation capabilities. In specific embodiments, models used may include:
1. LLAMA-Instruct: Known for its language generation capabilities.
2. BERT (Bidirectional Encoder Representations from Transformers): Primarily for its strength in understanding context and extracting topics.
3. XLNet: Chosen for its strong capabilities in handling permuted sequences, which helps in understanding complex sentence structures.

In some variations, the model may be deployed with default temperature hyperparameters, for instance, a temperature of 0.7 that provides a balance of randomness, or creativity, versus more deterministic results. Straightforward prompts like “Summarize this text:” may be applied to evaluate the model's ability to generate summaries and extract key topics from a text corpus, for instance as drawn from various brand or product related online comments and reviews. In some aspects, simple, direct prompts may be applied commonly across all models: “Summarize this text:” and “Identify key topics.” Outcomes may be evaluated in accordance with ROUGE (RecallOriented Understudy for Gisting Evaluation) scores, a set of metrics used to evaluate the quality of text summarization and machine generated text compared to a set of reference texts (often created by humans). In this manner, given multiple summaries or documents describing the same content, how closely a machine generated summary matches these ideal versions may be evaluated or indicated by way of the ROUGE scores which provide an automated way to thus quantify text similarity, helping researchers and developers assess how effective a machine generated summary is in capturing the essential information, structure, and flow of a reference text. High ROUGE scores generally indicate that the model-produced summary successfully mirrors the human generated ones in containing key ideas and elements.

In some particular embodiments, the inputting may be based on providing a set of input prompts engineered in accordance with a context of user interest pertaining to one or more of (i) the text content, and (ii) a topic of interest in accordance with the classification of topics. In some aspects, the inputting may further specify or apply a temperature hyperparameter in a predetermined range from 0.5 to 0.9 that adjusts a balance between randomness and predictability in the output result of the LLM ensemble.

Prompt engineering can be applied to establish context to the LLMs, to refine the output of the LLM ensemble and present same more concisely. Prompts may be engineered and applied to the above 3 given models, for instance:
1. LLAMA-Instruct: Precision oriented constructs, “Provide a three sentence summary emphasizing uniqueness.”
2. BERTFT: Task specific scripts, “Extract and briefly explain major themes.”
3. GPT4-0 mini: Detailed direction, “Rephrase the key points succinctly.”

Dataset summarization logic module 105 also includes instructions for generating, based on performing respective natural language processing tasks in the one or more processor devices, (i) a baseline summary of the text content in accordance with the trained baseline LLM, and (ii) a classification of topics of the text context in accordance with the trained classification LLM.

In an embodiment of summary generation:
An original, general-purpose LLM generates a summary (S<sub>original</sub>) of a given text.
Multiple fine-tuned LLMs (LLM<sub>1</sub>, LLM<sub>2</sub>, . . . , LLM<sub>n</sub>), each specialized in a specific topic, generate summaries of the same text.
For each fine-tuned model, we generate the top 10 summaries (S<sub>1,1</sub>, S<sub>1,2</sub>, . . . , S<sub>1,10</sub>, S<sub>2,1</sub>, . . . , S<sub>n, 10</sub>).

In an embodiment of topic classification:
A classification model (or a specialized LLM) determines the topic(s)+summary of focus (T<sub>1</sub>, T<sub>2</sub>, . . . ) present in S<sub>original</sub>.
This may be multi-label classification, identifying multiple relevant topics.

Dataset summarization logic module 105, in embodiments, also includes instructions for generating respective finetuned LLM summaries of the text based at least in part upon inputting the text content to respective ones of the multiple finetuned LLMs, the multiple finetuned LLMs being selected in accordance with respective ones of the classification of topics. The fine-tuned LLMs may be deployed in generating relevant summaries for a given topic, based on been trained on specific topics which are of interest, in view of a given text content. In embodiments, each of finetuned LLM is finetuned in accordance with respective ones of selected topics in accordance with the classification of topics based on the input text content. In a particular embodiment related to summarization of text content that relates to product, services or brand reviews, for instance, a finetuning training dataset of text content is selected based on one or more of a high sentiment intensity rating and a net sentiment score (NSS) as described herein.

Dataset summarization logic module 105, in some aspects, also includes instructions for determining, based on a semantic similarity analysis performed in the one or more processors, respective text semantic similarity measures (also referred to herein as “similarity measures”) across the baseline summary compared to each of the respective finetuned LLM summaries.

In an embodiment of determining the similarity measures, or measurements as also referred to herein:
For each topic of interest T<sub>i</sub>, we compare related generated summary S<sub>original</sub> to the top 10 summaries for the same topic generated by the fine-tuned topic expert LLMs (LLM<sub>i</sub>).
We use a semantic similarity metric (e.g., cosine similarity of sentence embeddings, BERTScore) to quantify the similarity between S<sub>original</sub> and each of the 10 summaries LLM<sub>i</sub>.
The average similarity score for topic T<sub>i</sub> is calculated for each LLM<sub>i</sub>, when compared to S<sub>original</sub>:

$$\%\%$$

$$Similarity\_ \{ i \} = \backslash frac \{ 1 \} \text{} \{ 10 \} \backslash sum\_ \text{} \{ j = 1 \} ⋀ \{ 10 \} Similarity ( S\_ \{ original \} , S\_ \{ i , j \} )$$

$$\%\%$$

Dataset summarization logic module 105, in yet a further aspect, includes logic instructions for generating, as an output result of the LLM ensemble, a summarization of the text content for at least one topic of the classification of topics based at least in part on the respective similarity measures. In embodiments, the summarization for the at least one topic can be generated as the output result in accordance with applying a desired or predetermined threshold value of the similarity measure. Then, generating the summarization in accordance if the similarity measure exceeds the threshold similarity measure, and optionally tag and present the summarization for further human user review if the similarity measure associated with the summarization does not meet the desired threshold similarity measure.

In related aspects, generating the summarization may be an aggregated output based on a consensus of the trained baseline LLM, the trained classification LLM, and the multiple finetuned LLMs in accordance with the respective similarity measures. In another variation, generating the summarization may be based on a weighted contribution that prioritizes topic related summarization performance attributable to the trained baseline LLM, the trained classification LLM, and the multiple finetuned LLMs. In yet another aspect, generating the summarization may be based on a majority consensus of the trained baseline LLM, the trained classification LLM, and the multiple finetuned LLMs based at least in part on the respective similarity measures. In one particular embodiment, generating the summarization may be based on generating a Recall Oriented Understudy for Gisting Evaluation (ROUGE) score that indicates how accurately the LLM ensemble summarization mirrors a selected human expert generated summarization.

Dataset summarization logic module 105 further includes logic instructions wherein at least one of the multiple finetuned LLMs, the trained baseline LLM, and the trained classification LLM is trained. The training operations may include providing, via one or more input layers of a machine language (ML) neural network, a training dataset of text content, the neural network being constituted of one or more input layers interconnected with an output layer via a set of fully connected intermediate layers of the neural network, each of the set of fully connected intermediate layers including an initial matrix of weights, the ML neural network being instantiated in one or more processors of the computing system. And yet further, training a machine language neural network classifier based at least in part upon generating, at an output layer of the neural network, at least one of a summary of the text content, a classification of topics, and a summary of the text content in accordance with each of the classification of topics, the generating being based at least in part upon a natural language processing operation.

In additional aspects, the trained LLMs may be subjected to a validation process. The trained machine learning LLM neural network may be subjected to validation based on a training loss function and also an accuracy function expressed in accordance with the correlation between the training dataset and a selected validation dataset. In some instances, the training loss function comprises a total training loss and a total validation loss over a given number of training epochs. The accuracy function may comprise a total training accuracy and a total validation accuracy over the given number of training epochs, in particular embodiments.

Dataset summarization logic module 105 may also include logic instructions for fine-tuning the trained ML neural network. More particularly, LLMs selected in accordance with the classification of topics may be deployed in generating relevant summaries for a given topic and being trained as an “expert” on the specific topics. In this manner, each of such LLMs is finetuned in accordance with the selected topics, consistent with the classification of topics based on the input text content. In a particular embodiment related to summarization of text content produced by way of product, services or brand reviews, for instance, a finetuning training dataset of text content is selected based on one or more of a high sentiment intensity rating and a net sentiment score (NSS) as described herein.

FIG. 3 illustrates, in another example embodiment, method 300 of operation of a machine learning neural network LLM ensemble in performing summarization of text content. Examples of method steps described herein are related to deployment and use of machine learning based LLM ensemble system 100 as described herein, in conjunction with any of the techniques, method steps, devices and systems as described in regard to FIGS. 1-6 herein. According to one embodiment, the techniques are performed in processor 201 executing one or more sequences of software logic instructions that constitute dataset summarization logic module 105. In embodiments, instructions constituting dataset summarization logic module 105 may be read into memory 202 from machine-readable medium, such as memory storage devices. Executing the instructions of dataset summarization logic module 105 stored in memory 202 causes processor 201 to perform the process steps described herein. In alternative implementations, at least some hard-wired circuitry, including but not limited to field programmable gate array (FPGA) implementations, may be used in place of, or partly in combination with, the software logic instructions that constitute dataset summarization logic module 105 in order to implement example embodiments described herein. Thus, the examples described herein are not limited to any particular combination of hardware circuitry and software instructions.

At step 310, inputting the text content to a trained baseline LLM, the text content that includes at least an unstructured text dataset, the LLM ensemble including at least the trained baseline LLM, a trained classification LLM, and multiple finetuned LLMs, the LLM ensemble being instantiated in one or more processor devices of a computing system.

At step 320, generating, based on performing respective natural language processing tasks in the one or more processor devices, (i) a baseline summary of the text content in accordance with the trained baseline LLM, and (ii) a classification of topics of the text context in accordance with the trained classification LLM.

At step 330, generating respective finetuned LLM summaries of the text based at least in part upon inputting the text content to respective ones of the multiple finetuned LLMs, the multiple finetuned LLMs being selected in accordance with respective ones of the classification of topics.

At step 340, determining, based on a semantic similarity analysis performed in the one or more processors, respective text semantic similarity measures (“similarity measures”) across the baseline summary compared to each of the respective finetuned LLM summaries.

In an embodiment of summary generation:
An original, general-purpose LLM generates a summary (S<sub>original</sub>) of a given text.
Multiple fine-tuned LLMs (LLM<sub>1</sub>, LLM<sub>2</sub>, . . . , LLM<sub>n</sub>), each specialized in a specific topic, generate summaries of the same text.
For each fine-tuned model, we generate the top 10 summaries (S<sub>1,1</sub>, S<sub>1,2</sub>, . . . , S<sub>1,10</sub>, S<sub>2,1</sub>, . . . , S<sub>n, 10</sub>).

In an embodiment of topic classification:
A classification model (or a specialized LLM) determines the topic(s)+summary of focus (T<sub>1</sub>, T<sub>2</sub>, . . . ) present in S<sub>original</sub>.
This may be multi-label classification, identifying multiple relevant topics.

Dataset summarization logic module 105, in embodiments, also includes instructions for generating respective finetuned LLM summaries of the text based at least in part upon inputting the text content to respective ones of the multiple finetuned LLMs, the multiple finetuned LLMs being selected in accordance with respective ones of the classification of topics. The fine-tuned LLMs may be deployed in generating relevant summaries for a given topic, based on been trained on specific topics which are of interest, in view of a given text content. In embodiments, each of finetuned LLM is finetuned in accordance with respective ones of selected topics in accordance with the classification of topics based on the input text content. In a particular embodiment related to summarization of text content that relates to product, services or brand reviews, for instance, a finetuning training dataset of text content is selected based on one or more of a high sentiment intensity rating and a net sentiment score (NSS) as described herein.

Dataset summarization logic module 105, in some aspects, also includes instructions for determining, based on a semantic similarity analysis performed in the one or more processors, respective text semantic similarity measures (also referred to herein as “similarity measures”) across the baseline summary compared to each of the respective finetuned LLM summaries.

In an embodiment of determining the similarity measures, or measurements as also referred to herein:
For each topic of interest T<sub>i</sub>, we compare related generated summary S<sub>original</sub> to the top 10 summaries for the same topic generated by the fine-tuned topic expert LLMs (LLM<sub>i</sub>).
We use a semantic similarity metric (e.g., cosine similarity of sentence embeddings, BERTScore) to quantify the similarity between S<sub>original</sub> and each of the 10 summaries LLM<sub>i</sub>.
The average similarity score for topic T<sub>i</sub> is calculated for each LLM<sub>i</sub>, when compared to S<sub>original</sub>:

$$\%\%$$

$$Similarity\_ \{ i \} = \backslash frac \{ 1 \} \text{} \{ 10 \} \backslash sum\_ \text{} \{ j = 1 \} ⋀ \{ 10 \} Similarity ( S\_ \{ original \} , S\_ \{ i , j \} )$$

$$\%\%$$

At step 350, generating, as an output result of the LLM ensemble, a summarization of the text content for at least one topic of the classification of topics based at least in part on the respective similarity measures.

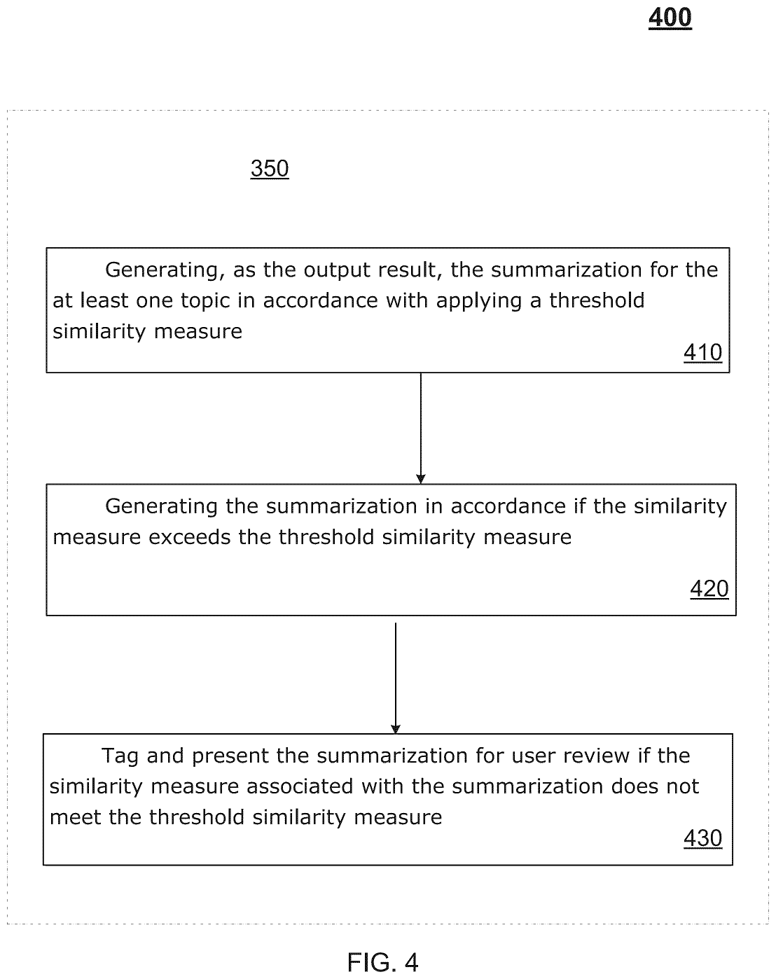

FIG. 4 illustrates, in an example embodiment, method 400 provides further summarization details of operation of the machine learning neural network LLM ensemble deployed in summarization of text content. Examples of method steps described herein are related to deployment and use of machine learning based LLM ensemble system 100 as described herein, in conjunction with any of the techniques, method steps, devices and systems as described in regard to FIGS. 1-6 herein. According to one embodiment, the techniques are performed in processor 201 executing one or more sequences or configurations of software logic instructions that constitute dataset summarization logic module 105. In embodiments, instructions constituting dataset summarization logic module 105 may be read into memory 202 from machine-readable medium, such as memory storage devices. Executing the instructions of dataset summarization logic module 105 stored in memory 202 causes processor 201 to perform the process steps described herein. In alternative implementations, at least some hard-wired circuitry, including but not limited to field programmable gate array (FPGA) implementations, may be applied in place of, or in combination with, the software logic instructions that constitute dataset summarization logic module 105 in order to implement example embodiments described herein. Thus, the examples described herein are not limited to any particular combination of hardware circuitry and software instructions.

At step 410, generating, as the output result, the summarization for the at least one topic in accordance with applying a desired or predetermined threshold value of similarity measure.

At step 420, generating the summarization in accordance if the similarity measure exceeds the threshold similarity measure.

At step 430, optionally tag and present the summarization for user review if the similarity measure associated with the summarization does not meet the desired threshold similarity measure.

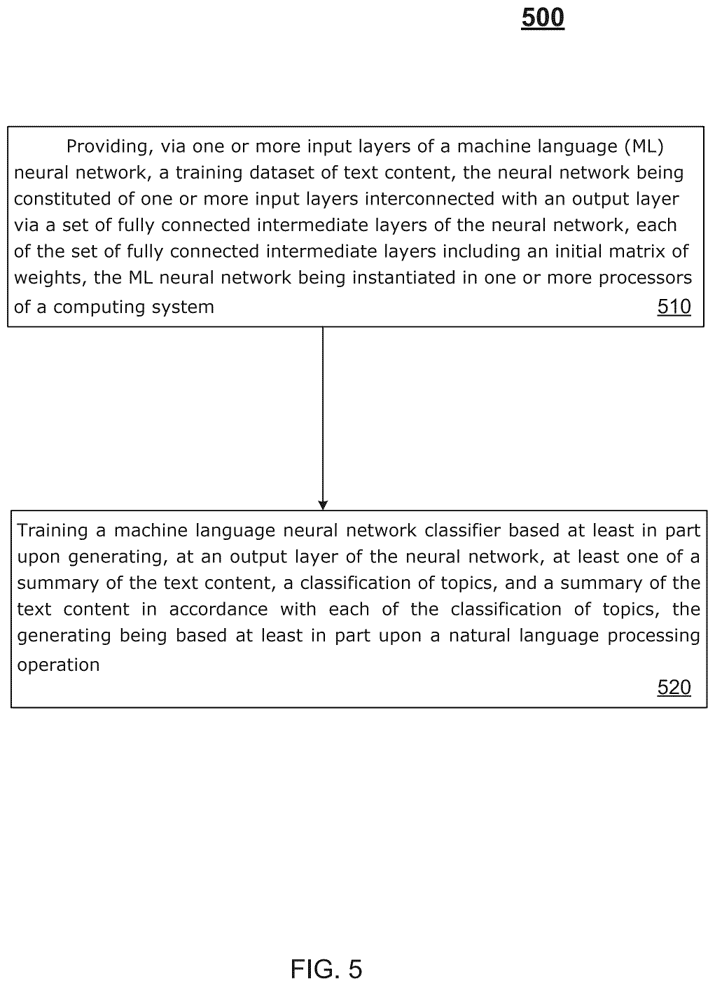

FIG. 5 illustrates, in an example embodiment, method 500 of training individual, or component, models constituting the machine learning neural network LLM ensemble in summarization of text content. Or more specifically, any one or more components of: the multiple finetuned LLMs, the trained baseline LLM, and the trained classification LLM. In the example embodiment depicted in FIG. 5, method 500 may be deployed in conjunction with the steps, or any portions thereof, as described herein with regard to any one of FIGS. 3, 4 and 6.

At step 510, providing, via one or more input layers of a machine language (ML) neural network, a training dataset of text content, the neural network being constituted of one or more input layers interconnected with an output layer via a set of fully connected intermediate layers of the neural network, each of the set of fully connected intermediate layers including an initial matrix of weights, the ML neural network being instantiated in one or more processors of the computing system.

At step 520, training a machine language neural network classifier based at least in part upon generating, at an output layer of the neural network, at least one of a summary of the text content, a classification of topics, and a summary of the text content in accordance with each of the classification of topics, the generating being based at least in part upon a natural language processing operation.

In some embodiments, the ML neural network as trained may be validated based on a training loss function and an accuracy function expressed in accordance with the correlation between the training dataset and a validation dataset as selected or provided. In particular example embodiments, the training loss function may comprise a total training loss and a total validation loss over a given number of training epochs, and the accuracy function may comprise a total training accuracy and a total validation accuracy over that number of training epochs.

In some aspects, the training operations may be continually repeated with a goal of optimizing the correlation between the training dataset and text summarization output, for example until the correlation meets or exceeds a predetermined, or desired, threshold probabilistic confidence level, for example a confidence level of 90% or greater.

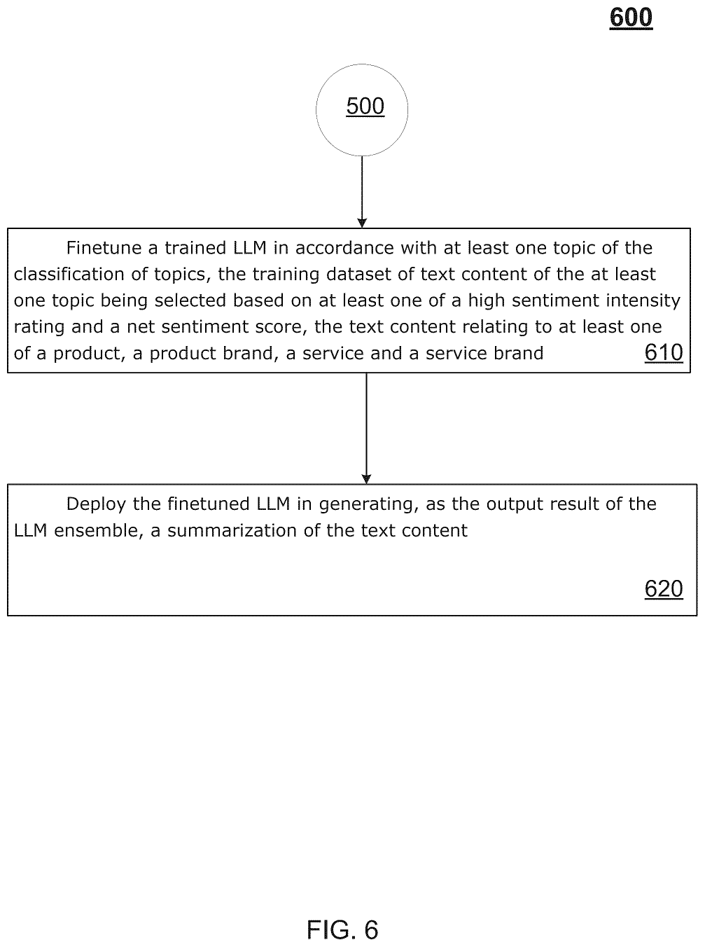

FIG. 6 illustrates, in an example embodiment, method 600 of deploying a machine learning neural network LLM ensemble in summarization of text content based on sentiment expressions contained therein. The operations depicted in FIG. 6, may be performed in conjunction with the techniques, or portions thereof, as described in any one of FIGS. 3-5.

At step 610, finetune a trained LLM in accordance with at least one topic of the classification of topics, the training dataset of text content of the at least one topic being selected based on at least one of a high sentiment intensity rating and a net sentiment score, the text content relating to at least one of a product, a product brand, a service and a service brand.

At step 620, deploy the finetuned trained LLM in generating, as the output result of the LLM ensemble, a summarization of the text content. In embodiments, the finetuned LLM is finetuned in accordance with at least one topic of the classification of topics, the training dataset of text content of the at least one topic being selected based on at least one of a high sentiment intensity rating and a net sentiment score as described herein.

In embodiments, the summarization for the at least one topic can be generated as the output result in accordance with applying a desired or predetermined threshold value of the similarity measure. Then, generating the summarization in accordance if the similarity measure exceeds the threshold similarity measure, and optionally tag and present the summarization for further human user review if the similarity measure associated with the summarization does not meet the desired threshold similarity measure.

In related aspects, generating the summarization may be an aggregated output based on a consensus of the trained baseline LLM, the trained classification LLM, and the multiple finetuned LLMs in accordance with the respective similarity measures. In another variation, generating the summarization may be based on a weighted contribution that prioritizes topic related summarization performance attributable to the trained baseline LLM, the trained classification LLM, and the multiple finetuned LLMs. In yet another aspect, generating the summarization may be based on a majority consensus of the trained baseline LLM, the trained classification LLM, and the multiple finetuned LLMs based at least in part on the respective similarity measures. In one particular embodiment, generating the summarization may be based on generating a Recall Oriented Understudy for Gisting Evaluation (ROUGE) score that indicates how accurately the LLM ensemble summarization mirrors a selected human expert generated summarization.

Although embodiments are described in detail herein with reference to the accompanying drawings, it is intended that disclosures herein not be limited to literal depictions of the embodiments illustrated by way of examples. As such, many modifications and equivalents of the machine learning based techniques will be apparent to practitioners skilled in the art. Accordingly, it is intended that the invention encompasses scope in accordance with the following claims and their equivalents. Furthermore, it is contemplated that a particular feature described either individually or as part of an embodiment can be combined with other individually described features, or portions of other embodiments described herein. Thus, absence of described particular combinations does not preclude the inventor from claiming rights to such combinations.

What is claimed is:

1. A method of generating a summarization of text content, the method performed in a machine learning neural network large language model (LLM) ensemble, and comprising:
inputting the text content to a trained baseline LLM, the text content that includes at least an unstructured text dataset, the LLM ensemble including at least the trained baseline LLM, a trained classification LLM, and multiple finetuned LLMs, the LLM ensemble being instantiated in one or more processor devices of a computing system;
generating, based on performing respective natural language processing tasks in the one or more processor devices, (i) a baseline summary of the text content in accordance with the trained baseline LLM, and (ii) a classification of topics of the text context in accordance with the trained classification LLM;
generating respective finetuned LLM summaries of the text based at least in part upon inputting the text content to respective ones of the multiple finetuned LLMs, the multiple finetuned LLMs being selected in accordance with respective ones of the classification of topics;
determining, based on a semantic similarity analysis performed in the one or more processors, respective text semantic similarity measures (“similarity measures”) across the baseline summary compared to each of the respective finetuned LLM summaries; and
generating, as an output result of the LLM ensemble, a summarization of the text content for at least one topic of the classification of topics based at least in part on the respective similarity measures.

2. The method of claim 1 wherein the text content of the unstructured text dataset further comprises at least one of image content and audio content.

3. The method of claim 1 wherein the inputting comprises providing a set of input prompts, the set of input prompts being engineered in accordance with a context of user interest pertaining to at least one of: (i) the text content, and (ii) a topic of interest in accordance with the classification of topics.

4. The method of claim 3 wherein the inputting further comprises a temperature hyperparameter in a predetermined range from 0.5 to 0.9 that adjusts a balance between randomness and predictability in the output result.

5. The method of claim 1 wherein generating the summarization comprises an aggregated output based on a consensus of the trained baseline LLM, the trained classification LLM, and the multiple finetuned LLMs in accordance with the respective similarity measures.

6. The method of claim 1 wherein generating the summarization comprises a weighted contribution that prioritizes topic related summarization performance attributable to the trained baseline LLM, the trained classification LLM, and the multiple finetuned LLMs.

7. The method of claim 1 wherein generating the summarization comprises a majority consensus of the trained baseline LLM, the trained classification LLM, and the multiple finetuned LLMs based at least in part on the respective similarity measures.

8. The method of claim 1 wherein generating the summarization further comprises generating a Recall Oriented Understudy for Gisting Evaluation (ROUGE) score that indicates how accurately the LLM ensemble summarization mirrors a selected human expert generated summarization.

9. The method of claim 1 wherein at least one of the multiple finetuned LLMs, the trained baseline LLM, and the trained classification LLM is trained in accordance with training operations comprising:
providing, via one or more input layers of a machine language (ML) neural network, a training dataset of text content, the neural network being constituted of one or more input layers interconnected with an output layer via a set of fully connected intermediate layers of the neural network, each of the set of fully connected intermediate layers including an initial matrix of weights, the ML neural network being instantiated in one or more processors of the computing system; and
training a machine language neural network classifier based at least in part upon generating, at an output layer of the neural network, at least one of a summary of the text content, a classification of topics, and a summary of the text content in accordance with each of the classification of topics, the generating being based at least in part upon a natural language processing operation.

10. The method of claim 9 wherein the finetuned LLM is finetuned in accordance with at least one topic of the classification of topics, the training dataset of text content of the at least one topic being selected based on at least one of a high sentiment intensity rating and a net sentiment score.

11. A server computing system implementing summarization of text content, the server computing system comprising:
one or more processor devices; and
a memory storing instructions executable in the one or more processor devices, the instructions causing the one or more processor devices to execute operations comprising:
inputting the text content to a trained baseline LLM of a LLM ensemble that includes at least the trained baseline LLM, a trained classification LLM, and multiple finetuned LLMs, the text content including at least an unstructured text dataset, the LLM ensemble being instantiated in one or more processor devices of a computing system;
generating, based on performing respective natural language processing tasks in the one or more processor devices, (i) a baseline summary of the text content in accordance with the trained baseline LLM, and (ii) a classification of topics of the text context in accordance with the trained classification LLM;
generating respective finetuned LLM summaries of the text based at least in part upon inputting the text content to respective ones of the multiple finetuned LLMs, the multiple finetuned LLMs being selected in accordance with respective ones of the classification of topics;
determining, based on a semantic similarity analysis performed in the one or more processors, respective text semantic similarity measures (“similarity measures”) across the baseline summary compared to each of the respective finetuned LLM summaries; and
generating, as an output result of the LLM ensemble, a summarization of the text content for at least one topic of the classification of topics based at least in part on the respective similarity measures.

12. The server computing system of claim 11 wherein the unstructured text dataset further comprises at least one of image content and audio content.

13. The server computing system of claim 11 wherein the inputting comprises providing a set of input prompts, the set of input prompts being engineered in accordance with a context of user interest pertaining to at least one of: (i) the text content, and (ii) a topic of interest in accordance with the classification of topics.

14. The server computing system of claim 13 wherein the inputting further comprises a temperature hyperparameter in a predetermined range from 0.5 to 0.9 that adjusts a balance between randomness and predictability in the output result.

15. The server computing system of claim 11 wherein generating the summarization comprises an aggregated output based on a consensus of the trained baseline LLM, the trained classification LLM, and the multiple finetuned LLMs in accordance with the respective similarity measures.

16. The server computing system of claim 11 wherein generating the summarization comprises a weighted contribution that prioritizes topic related summarization performance attributable to the trained baseline LLM, the trained classification LLM, and the multiple finetuned LLMs.

17. The server computing system of claim 11 wherein generating the summarization comprises a majority consensus of the trained baseline LLM, the trained classification LLM, and the multiple finetuned LLMs based at least in part on the respective similarity measures.

18. The server computing system of claim 11 wherein at least one of the multiple finetuned LLMs, the trained baseline LLM, and the trained classification LLM is trained in accordance with training operations comprising:
providing, via one or more input layers of a machine language (ML) neural network, a training dataset of text content, the neural network being constituted of one or more input layers interconnected with an output layer via a set of fully connected intermediate layers of the neural network, each of the set of fully connected intermediate layers including an initial matrix of weights, the ML neural network being instantiated in one or more processors of the computing system; and
training a machine language neural network classifier based at least in part upon generating, at an output layer of the neural network, at least one of a summary of the text content, a classification of topics, and a summary of the text content in accordance with each of the classification of topics, the generating being based at least in part upon a natural language processing operation.

19. The server computing system of claim 18 wherein the finetuned LLM is finetuned in accordance with at least one topic of the classification of topics, the training dataset of text content of the at least one topic being selected based on at least one of a high sentiment intensity rating and a net sentiment score.

20. A non-transitory computer readable storage media storing instructions which, when executed by one or more processors devices, cause the one or more processor devices to perform operations comprising:
inputting text content to a trained baseline LLM of a LLM ensemble that includes at least the trained baseline LLM, a trained classification LLM, and multiple finetuned LLMs, the text content including at least an unstructured text dataset, the LLM ensemble being instantiated in one or more processor devices of a computing system;
generating, based on performing respective natural language processing tasks in the one or more processor devices, (i) a baseline summary of the text content in accordance with the trained baseline LLM, and (ii) a classification of topics of the text context in accordance with the trained classification LLM;
generating respective finetuned LLM summaries of the text based at least in part upon inputting the text content to respective ones of the multiple finetuned LLMs, the multiple finetuned LLMs being selected in accordance with respective ones of the classification of topics;
determining, based on a semantic similarity analysis performed in the one or more processors, respective text semantic similarity measures (“similarity measures”) across the baseline summary compared to each of the respective finetuned LLM summaries; and
generating, as an output result of the LLM ensemble, a summarization of the text content for at least one topic of the classification of topics based at least in part on the respective similarity measures.
